(19) United States
(12) Patent Application Publication
(10) Pub. No.: US 2007/0232216 A1
(43) Pub. Date: Oct. 4, 2007

(54) Register for air conditioning

(75) Inventor: Minoru Shibata, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/730,220

(22) Filed: Mar. 30, 2007

(30) Foreign Application Priority Data
Mar. 30, 2006 (JP) 2006-095646

(51) Int. Cl. B60H 1/34

(52) U.S. Cl. 454/155; 454/152

(57) ABSTRACT

An air-conditioning register includes a cylinder-shaped retainer, and a fin assembly, which includes a plurality of synchronously swingable fins. The fin assembly includes a fin sub-assembly. The fin sub-assembly includes the fins, which neighbor to each other, in a quantity of from two or more to less than a total number of the fins. The fins, which belong to an identical fin sub-assembly, make a first imaginary plane, which passes the swing shafts of the fins. The fins, which neighbor to each other but are free of belonging to the identical fin sub-assembly, make a second imaginary plane, which passes the swing shafts of the fins. The first imaginary plane and the second imaginary plane cross to each other. The fins, which belong to the identical fin sub-assembly, are disposed one after another consecutively when the fins swing to a predetermined position, respectively.

### BACKGROUND OF THE INVENTION

1. Field of the Invention

The present invention relates to a register for air conditioning, register which is connected with air conditioner to control the blowing direction of air-conditioning air flowing toward the inside of rooms, such as vehicle passenger rooms.

2. Description of the Related Art

An instrument panel of automobile is provided with such a register as disclosed in Japanese Unexamined Patent Publication (KOKAI) Gazette No. 11-139,156, for instance. A register blows out air-conditioning air, which an air-conditioner produces, and controls the blowing direction of air-conditioning air.

FIG. 6 illustrates one of conventional registers for air conditioning. As shown in the drawing, a conventional register comprises a retainer 100, and a fin assembly 400. The retainer 100 is formed as a cylinder shape, and demarcates a flow passage for air-conditioning air and an outlet opening 120 therefor. The fin assembly 400 comprises a plurality of fins 401. The fins 401 are disposed swingably about a swing shaft 460, respectively, inside the retainer 100. Moreover, the fins 401 are disposed parallelly to each other. In the conventional register shown in the drawing, the fins 401 swing about the swing shaft 406, respectively, to control the air-conditioning air, which flows through within the retainer 100.

In the conventional register shown in FIG. 6, when the fins 401 swing, the fins 401 and an imaginary plane 650 (hereinafter referred to as an “outlet plane” 650), which involves the outlet opening 120 of the retainer 100, make a changing angle, respectively. Note that, when the angle, which the fins 401 and the outlet plane 650 make, approaches 90 deg., the clearance “W” between the neighboring fins 401 enlarges. On the other hand, when the angle, which the fins 401 and the outlet plane 650 make, approaches 0 deg., the clearance “W” between the neighboring fins 401 decreases.

Recently, however, it has been general that an automobile is equipped with a car navigation system. Moreover, it has been a general practice to dispose a monitor for car navigation system in an instrument panel and dispose a register for air conditioning above the monitor. Since the top end of the instrument panel is formed as an inclined shape, the outlet plane 650 of the conventional air-conditioning register is also formed as an inclined shape, which matches the inclined top end of the instrument panel, as illustrated in FIG. 7, in order to dispose the conventional air-conditioning register above a car navigation system's monitor. As can be seen from the drawing, in the conventional air-conditioning register whose outlet plane 650 is formed as an inclined shape, the clearance “W” between the neighboring fins 401 is small excessively, especially, when controlling the blowing direction of air-conditioning air downward.

Therefore, the conventional air-conditioning register illustrated in FIG. 6 or 7 might exhibit the clearance “W,” which is small excessively or large excessively, when swinging the fins 401, depending on the disposed location or quantity of the fins 401. When the conventional air-conditioning register exhibits an excessively small clearance “W,” it produces a large pressure loss, and air-conditioning air, which flows through such an excessively small clearance “W,” produces loud noises. On the other hand, when the conventional air-conditioning register exhibits an excessively large clearance “W.” it cannot control the blowing direction of air-conditioning air, which flows through such an excessively large clearance “W,” with high accuracy. Moreover, the conventional air-conditioning register illustrated in FIG. 7 might suffer from a problem that it cannot control the blowing direction of air-conditioning air downward with high accuracy because the neighboring fins 401 overlap in less overlapping magnitude in the blowing direction of air-conditioning air.

Regarding the possible problem as presented above, it is believed possible to control the blowing direction of air-conditioning air downward with high accuracy when the fins 401 are formed longer in the blowing direction of air-conditioning air so as to overlap the neighboring fins 401 in enlarged overlapping magnitude “O.M.” (hereinafter referred to as “overlapping magnitude between fins 401) in the blowing direction of air-conditioning air. However, such elongated fins 401 have closed the flow passage for air-conditioning air virtually to increase the pressure loss more. Moreover, air-conditioning air, which flows through such the clearance “W” between the neighboring elongated fins 401, has produced louder noises. When the quantity of elongated fins 401 is reduced, it is believed possible to enlarge the clearance “W” between the neighboring elongated fins 401. However, the conventional register with a reduced quantity of elongated fins 401 has exhibited an excessively large clearance “W” when directing the elongated fins 401 in directions other than downward so that it cannot control the blowing direction of air-conditioning air with high accuracy in directions other than downward.

### SUMMARY OF THE INVENTION

The present invention has been developed in view of the aforementioned circumstances. It is therefore an object of the present invention to provide an air-conditioning register which can inhibit the enlargement of pressure loss; can reduce noises; and can control the blowing direction of air-conditioning air with high accuracy.

A register for air conditioning according to the present invention can solve the aforementioned problems, and comprises:

a cylinder-shaped retainer demarcating a flow passage for air-conditioning air and an outlet opening therefor; and

a fin assembly comprising a plurality of fins, the fins disposed parallelly to each other and swingably about a swing shaft, respectively, inside the retainer;

the fin assembly comprising a fin sub-assembly, the fin sub-assembly comprising the fins, which neighbor to each other, in a quantity of from two or more to less than a total number of the fins;

the fins, which belong to an identical fin sub-assembly, making a first imaginary plane, which passes the swing shafts of the fins;

the fins, which neighbor to each other but are free of belonging to the identical fin sub-assembly, making a second imaginary plane, which passes the swing shafts of the fins;

the first imaginary plane and the second imaginary plane crossing to each other; and

the fins, which belong to the identical fin sub-assembly, being disposed one after another consecutively when the fins swing to a predetermined position, respectively.

It is advisable that the present air-conditioning register can be provided with any one of the following first, second, third and fourth preferable modes, or a plurality of them.

(1) The fins, which belong to the identical fin sub-assembly, can preferably be disposed one after another consecutively in a linear manner when the fins swing to the predetermined position, respectively.

(2) The retainer can preferably make a third imaginary plane, which involves the outlet opening; the third imaginary plane and the fins, which have swung to the predetermined position, can preferably make a first angle; the third imaginary plane and the fins, which are located at positions other than the predetermined position, can preferably make a second angle; and the first angle can preferably be smaller than the second angle.

(3) The retainer can preferably make a third imaginary plane, which involves the outlet opening; and the third imaginary plane can preferably cross an extending direction of the retainer at an angle other than right angle.

(4) The fins can preferably swing in an up/down direction with respect to the retainer, and can preferably control a blowing direction of the air-conditioning air downward at the predetermined position.

The present air-conditioning register comprises a fin assembly, which comprises a plurality of fins. The fin assembly comprises a fin sub-assembly. The fin sub-assembly comprises the fins, which neighbor to each other, in a quantity of from two or more and less than a total number of the fins. Note that, the fins, which belong to an identical fin sub-assembly, is disposed one after another consecutively when the fins swing to a predetermined position, respectively. In other words, the fins, which belong to an identical fin sub-assembly, are superimposed to each other to operate like a single fin. Accordingly, a substantial quantity of the fins when being placed at the predetermined position is less than a quantity of the fins when being placed at positions other than the predetermined position. Consequently, when the fins are located at the predetermined position, the present air-conditioning register can fully provide a flow passage for air-conditioning air that is, the clearance between the fins which neighbor to each other but free of belonging to the identical fin-sub assembly. Therefore, even when the present air-conditioning register comprises the fins, whose length is elongated in the flowing direction of air-conditioning air in order to enlarge the overlapping magnitude of the neighboring fins at the predetermined position, the clearance between the neighboring fins hardly enlarges when the fins are located at positions other than the predetermined position.

Moreover, in the present air-conditioning register, the fins, which belong to an identical fin sub-assembly, make a first imaginary plane, which passes the swing shafts of the fins; the fins, which neighbor to each other but are free of belonging to the identical fin sub-assembly, make a second imaginary plane, which passes the swing shafts of the fins; and the first imaginary plane and the second imaginary plane cross to each other. Accordingly, all of the fins are hardly disposed one after another consecutively at the predetermined position. Consequently, it is possible to provide a sufficient clearance between the fins, which neighbor to each other but are free of belonging to the identical fin sub-assembly.

Therefore, the present air-conditioning register can inhibit the enlargement of pressure loss, can reduce noises, and can control the blowing direction of air-conditioning air with high accuracy.

When the present air-conditioning register is further provided with the first preferable mode, it can control the blowing direction of air-conditioning air with much higher accuracy while inhibiting the pressure loss from enlarging.

When the present air-conditioning register is further provided with the second preferable mode, regardless of the swing angle of the swinging fins, it can more inhibit the pressure loss from enlarging, can reduce noises more, and can control the blowing direction of air-conditioning air with much higher accuracy. As described above, note that, in the conventional air-conditioning register, the more the angle, which the fins and the outlet plane make, approaches 90 deg., the larger the clearance “W” between the neighboring fins enlarges; and that the more the angle, which the fins and the outlet plane make, approaches 0 deg., the smaller the clearance “W” between the neighboring fins decreases. As a result, the conventional air-conditioning register shown in FIGS. 6 and 7 suffers from problems that, when the fins 401 swing to a position at which the angle, which the fins 401 and the outlet plane 650 make, becomes minimum, it has exhibited the enlarged pressure loss; that it has produced noises; and that it cannot control the blowing direction of air-conditioning air with high accuracy. On the other hand, the present air-conditioning register provided with the second preferable mode can produce a sufficient clearance between the fins, which neighbor to each other but are free of belonging to the identical fin sub-assembly, even when the angle, which the fins and the outlet plane make, becomes minimum, that is, when the clearance between the neighboring fins becomes minimum. Therefore, regardless of the swing angle of the swinging fins, the present air-conditioning register provided with the second preferable mode can more inhibit the pressure loss from enlarging, can reduce noises more, and can control the blowing direction of air-conditioning air with much higher accuracy.

Note that, in the present specification, the “angle, which the fins and the outlet plane make, at a predetermined position,” and the “angle, which the fins and the outlet plane make, at positions other than the predetermined position” designate acute angles of the angles, which the fins and the outlet plane make, at the respective positions.

When the present air-conditioning register is further provided with the third preferable mode, it can make a desirable air-conditioning register provided with an outlet opening that is configured in an inclined manner. On the contrary, note that, in the conventional air-conditioning register which is provided with the inclined outlet plane 650 as illustrated in FIG. 7, the clearance “W” between the neighboring fins 401 has become small extremely when the fins 401 swing to a position at which the angle, which the fins and the outlet plane 650 make, is minimum. Accordingly, as described above, the conventional air-conditioning register provided with the inclined outlet plane 650 might have exhibited the enlarged pressure loss, might have generated louder noises, and might have been unable to control the blowing direction of air-conditioning air with high accuracy. On the other hand, in the present air-conditioning register provided with the third preferable mode, even when fully enlarging the flow passage of air-conditioning air at the predetermined position (that is, the clearance between the fins, which neighbor to each other but are free of belonging to the identical fin sub-assembly), the flow passage of air-conditioning air at positions other than the predetermined position (that is, the clearance between the fins, which neighbor to each other at positions other than the predetermined position) hardly enlarges excessively, or does not at all enlarge more than necessary. Consequently, the present air-conditioning register provided with the third preferable mode can make an air-conditioning register, which is equipped with an inclined outlet opening, desirably.

When the present air-conditioning register is further provided with the fourth preferable mode, it can make a desirable air-conditioning register which can be disposed along with a monitor for car navigation system in an automobile instrument panel. On the contrary, note that, when the conventional air-conditioning register is disposed along with a monitor for car navigation system in an automobile instrument panel, the angle, which the fins 401 and the outlet plane 650 make, becomes very small upon directing the fins 401 downward so that the clearance between the downwardly-directed neighboring fins 401 becomes very small as illustrated in FIG. 7. Accordingly, it is difficult for the conventional air-conditioning register to control the blowing direction of air-conditioning air downward with high accuracy. On the other hand, the present air-conditioning register provided with the forth preferable mode can fully secure the flow passage of air-conditioning air (that is, the clearance between the fins, which neighbor to each other but are free of belonging to the identical fin sub-assembly), when disposing the fins at the predetermined position (that is, directing the fins downward). Moreover, the present air-conditioning register provided with the forth preferable mode can fully minimize the flow passage of air-conditioning air when disposing the fins at positions other than the predetermined position (that is, the clearance between the fins, which neighbor to each other at positions other than the predetermined position). Consequently, even when the present air-conditioning register provided with the fourth preferable mode is disposed along with a monitor for car navigation system in an automotive instrument, it can control the blowing direction of air-conditioning air downward with high accuracy.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is an exploded perspective view for schematically illustrating an air-conditioning register according to an example of the present invention.

FIG. 2 is an explanatory diagram for illustrating one of the operations of the air-conditioning register according to the example of the present invention.

FIG. 3 is another explanatory diagram for illustrating the other one of the operations of the air-conditioning register according to the example of the present invention.

FIG. 4 is another explanatory diagram for illustrating the other one of the operations of the air-conditioning register according to the example of the present invention.

FIG. 5 is another explanatory diagram for illustrating the other one of the operations of the air-conditioning register according to the example of the present invention.

FIG. 6 is an explanatory diagram for illustrating one of the operations of a conventional air-conditioning register.

FIG. 7 is another explanatory diagram for illustrating the other one of the operations of the conventional air-conditioning register.

FIG. 8 is another explanatory diagram for illustrating the other one of the operations of the conventional air-conditioning register.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

In the present air-conditioning register, the fins, which belong to the identical fin sub-assembly, can be formed as the same configuration to each other, or can be formed as a different configuration to each other. Further, the position of the fins' swing shaft, the angle which the outlet plane and the fins make at the predetermined position, and the angle which the outlet plane and the fins make at positions other than the predetermined position can be set up depending the configuration of retainer and the configuration of fins. Furthermore, as far as the fins, which belong to the identical fin sub-assembly, are disposed one after another consecutively at the predetermined position, the fins can be disposed one after another consecutively in a curved manner, or can be disposed one after another consecutively while being bent one after another. Moreover, the fins, which belong to the identical fin sub-assembly, can contact with each other at the predetermined position, or can be disposed separately away from each other. In order that the present air-conditioning register can inhibit the enlargement of pressure loss more securely and can control the blowing direction of air-conditioning air with much higher accuracy, the fins, which belong to the identical fin sub-assembly, can preferably be disposed one after another consecutively in a linear manner at the predetermined position. In addition, in order to let air-conditioning air flow more smoothly in the present air-conditioning register, the fins, which belong to the identical fin sub-assembly, can preferably be disposed as closely as possible to each other, and can more preferably have a surface, which contacts with each other, respectively.

In order that the present air-conditioning register can control the blowing direction of air-conditioning air with much higher accuracy, the present air-conditioning register can preferably comprise the fin sub-assembly in a quantity of two or more.

The present air-conditioning register can comprise the fin assembly solely, or can comprise the fin assembly in a quantity of two or more as well. For example, two fin assemblies are available, that is, a fin assembly which comprises a plurality of fins for controlling the blowing direction of air-conditioning air upward/downward (hereinafter referred to as a “horizontal fin assembly”), and another fin assembly which comprises a plurality of fins for controlling the blowing direction of air-conditioning air right/left (hereinafter referred to as a “vertical fin assembly”). It is advisable that the present air-conditioning register can comprise both horizontal fin assembly and vertical fin assembly. When the present air-conditioning register comprises two or more fin assemblies, all of the fin assemblies can comprise the fin sub-assembly, or only one of them can comprise the fin sub-assembly.

Note that, in the present air-conditioning register, it is advisable to provide the fins themselves with a device for synchronously swinging the fins, which belong to the identical fin sub-assembly, or to provide the fins with such a device independently of them. Moreover, in addition to the retainer and fin assembly, it is advisable to provide the present air-conditioning register with a variety of devices, which known air-conditioning registers have been equipped with, such as a device for operating the fins swingably.

### EXAMPLE

An air-conditioning register according to a specific example of the present invention will be hereinafter described in detail with reference to the accompanying drawings.

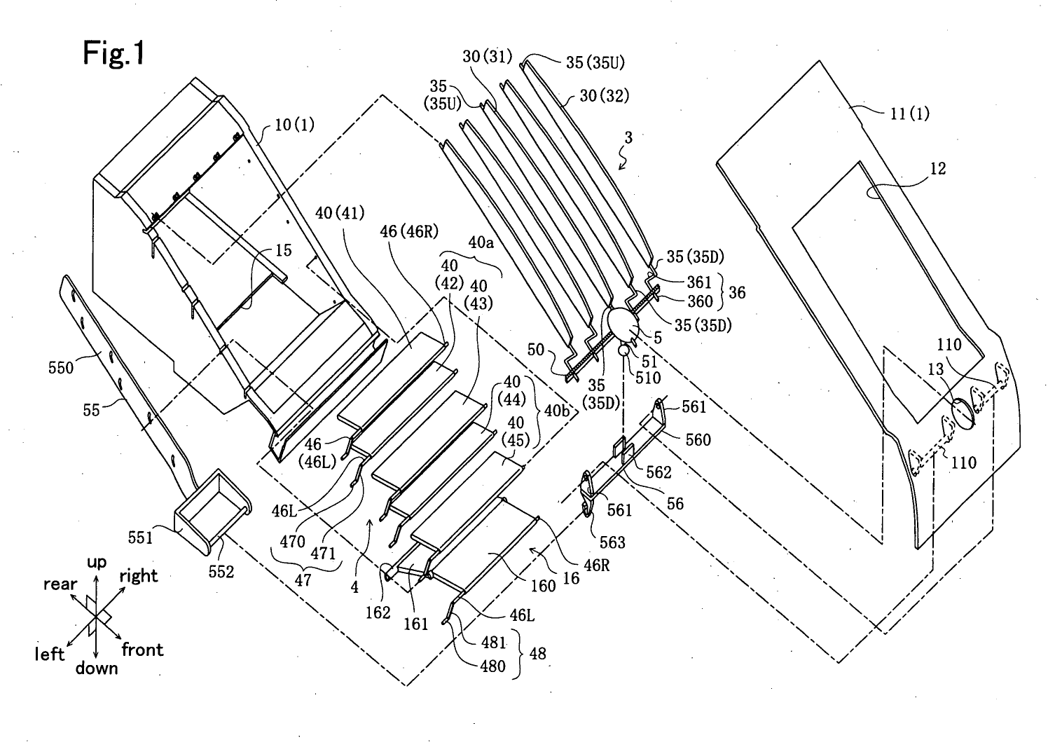

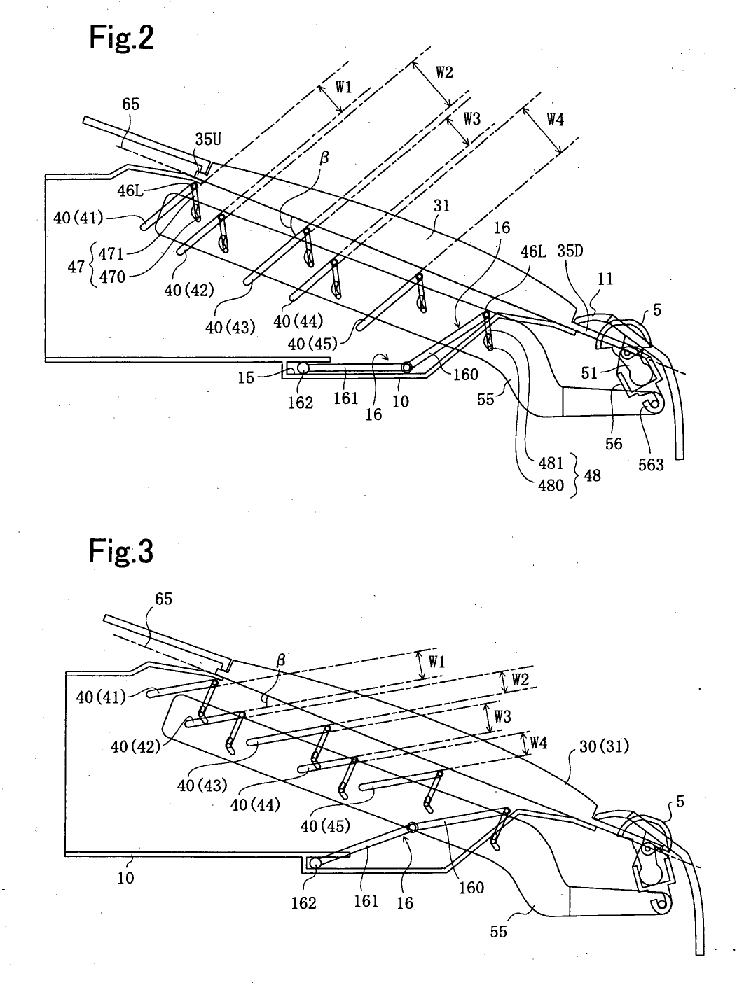

For example, an air-conditioning register according to an example of the present invention is disposed along with a monitor (not shown in the drawings) for car navigation system in an automobile instrument panel. Specifically, FIG. 1 schematically illustrates the air-conditioning register according to Example of the present invention in an exploded perspective view. FIGS. 2 through 5 illustrate the operations of the air-conditioning register according to Example in an explanatory diagram, respectively. Note that FIGS. 2 through 5 show the air-conditioning register according to Example, which is viewed on the left side thereof. In the following descriptions on the air-conditioning register according to Example, the terms, “up,” “down,” “right,” “left,” “front” and “rear,” specify those “up,” “down,” “right,” “left,” “front” and “rear” designated in FIG. 1. Also note that the above-described preferable modes (1) through (4) are incorporated into the air-conditioning register according to Example.

As illustrated in FIG. 1, the air-conditioning register according to Example of the present invention comprises a retainer 1, and two fin assemblies 2 (that is, a vertical fin assembly 3, and a horizontal fin assembly 4). The retainer 1 comprises a retainer body 10, and a bezel 11. The retainer body 10 is formed as a substantially-squared cylinder shape, which extends in the front/rear direction and is opened at the opposite ends, the front and rear ends. The retainer body 10 is connected with a not-shown air conditioner at the rear end. The frame-shaped bezel 11 covers the front end of the retainer body 11. The bezel 11 has a substantially-rectangle-shaped opening at the substantial center. The opening makes an outlet opening 12. The outlet opening 12 is disposed in a tapering manner from small to large in the direction away from the rear top to the front bottom. Thus, the retainer 1's opening demarcates an imaginary outlet plane, which crosses the extending direction of the retainer 1 (that is, the front/rear direction) at an acute angle. In other words, the imaginary outlet plane crosses the extending direction of the retainer 1 at an angle other than right angle.

The air-conditioning register according to Example of the present invention comprises the two fin assemblies 2, i.e., the vertical fin assembly 3 and the horizontal fin assembly 4. The vertical fin assembly 3 comprises five vertical fins 30, which are disposed parallelly to each other in the right/left direction. Of the five vertical fins 30, the vertical fin 30, which is disposed at the center of the vertical fin assembly 3, will be hereinafter referred to as an “operating vertical fin 31,” and the other fins 30 will be hereinafter referred to as “ordinary vertical fins 32.” The vertical fins 30 are formed as a long plate shape, respectively. Moreover, the vertical fins 30 are provided with boss-shaped vertical swing shafts 35, 35 at the opposite ends in the longitudinal direction. One of the vertical swing shafts 35, 35, a top swing shaft 35U, is supported swingably in a clearance, which is formed between the top wall of the retainer body 11 and the rear surface of the bezel 11. The other one of the vertical swing shafts 35, 35, a bottom swing shaft 35D, is supported swingably in a clearance, which is formed between the bottom wall of the retainer body 11 and the rear surface of the bezel 11. In addition, the respective vertical fins 30 swing about the top swing shaft 35U and bottom swing shaft 35D synchronously in the right/left direction.

Specifically, as illustrated in FIG. 2, the bottom swing shaft 35D of the operating vertical fin 31 is extended downward linearly, and is supported swingably in a clearance, which is formed between the bottom wall of the retainer body 10 and the rear surface of the bezel 11. Moreover, at the leading end of the bottom swing shaft 35D of the operating vertical fin 31, an operating knob 5 is supported swingably about the operating vertical fin 5 in the up/down direction. In addition, the operating knob 5 is supported swingably in the right/left direction synchronously with the operating vertical fin 31. The operating knob 5 is formed as a semi-spherical shape on the front side. On the other hand, the rear side of the operating knob 5 is provided with a not-shown vertical-fins actuator, which extends rearward. The vertical-fins actuator is formed as a gear shape, which meshes with a later-described vertical-fins link member 50. As illustrated in FIG. 1, the bezel 11 is provided with a substantially-circle-shaped operating window 13. The front side of the operating knob 5 is fitted into the operating window 13 so that it is exposed to the outside.

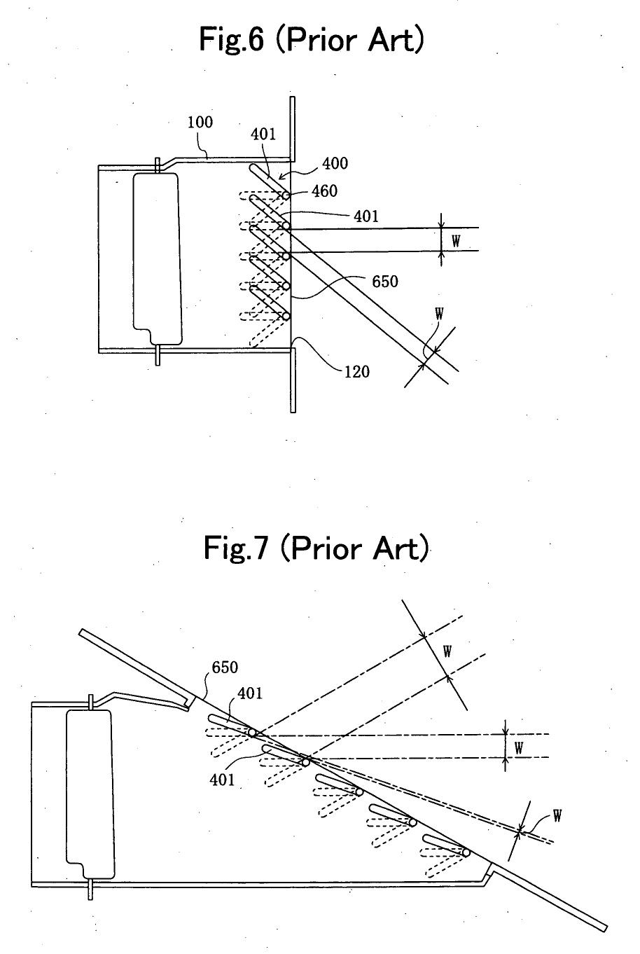

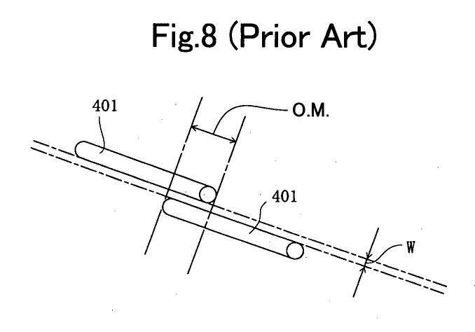

As can be see from FIG. 1, the bottom swing shafts 35D of the respective ordinary vertical fins 32 are supported swingably in clearances, which are formed between the bottom wall of the retainer body 10 and the rear surface of the bezel 11, respectively. The bottom swing shafts 35D of the respective ordinary vertical fins 32 are further provided with a vertical-fin-side link 36, which is disposed fixedly at the leading ends, respectively. As illustrated in FIG. 1, the vertical-fin-side links 36 comprise a leading end 360, and a connector 361, respectively. The leading ends 360 extend parallelly to the bottom swing shafts 35D. The connectors 361 connect the leading ends 360 to the bottom swing shafts 35D substantially perpendicularly. Thus, the leading ends 360 are disposed in a stepwise manner with respect to the bottom swing shafts 35D by way of the connectors 361. Moreover, the leading ends 360 are supported swingably through the vertical-fins link member 50. Note however that, in FIGS. 2 through 6, the vertical-fin-side links 36 are not shown.

As illustrated in FIG. 1, the vertical-fins link member 50 is formed as a long plate shape. The vertical-fins link member 50 is provided with a rack on the front face. The rack meshes with the vertical-fins actuator of the operating knob 5. When a user applies a force to the operating knob 5 horizontally in the right/left direction, the operating knob 5 swings in the right/left direction. Accordingly, the operating vertical fin 31 swings in the right/left direction synchronously with the swinging operating knob 5. When the operating vertical fin 31 swings in the right/left direction, the vertical-fins link member 50 slides in the right/left direction. Consequently, the ordinary vertical fins 32 swing in the right/left direction synchronously with the swinging operating vertical fin 31.

In the air-conditioning register according to Example of the present invention, the horizontal fin assembly 4 comprises five horizontal fins 40. As can be seen from FIG. 1, the five horizontal fins 40 are disposed parallelly to each other from the top rear side of the horizontal fin assembly 4 to the bottom front side thereof. The five horizontal fins 40 are hereinafter referred to as a first horizontal fin 41, a second horizontal fin 42, a third horizontal fin 43, a fourth horizontal fin 44 and a fifth horizontal fin 45 in this order from the top rear side of the horizontal fin assembly 4 to the bottom front side thereof. Note that the second horizontal fin 42 and the third horizontal fin 43 make a first horizontal-fin sub-assembly 40a. Moreover, the fourth horizontal fin 44 and the fifth horizontal fin 45 make a second horizontal-fin sub-assembly 40b. That is, in the air-conditioning register according to Example, the horizontal fin assembly 4 comprises two horizontal-fin sub-assemblies, i.e., the first horizontal-fin sub-assembly 40a and second horizontal-fin sub-assembly 40b.

The horizontal fins 40 are formed as a long-plate shape, respectively. Moreover, the horizontal fins 40 are provided with boss-shaped horizontal swing shafts 46, 46 at the opposite ends in the longitudinal direction. One of the horizontal swing shafts 46, 46, a left swing shaft 46L, is fitted swingably through the left wall of the retainer body 10. The other one of the horizontal swing shafts 46, 46, a right swing shaft 46R, is fitted swingably through the right wall of the retainer body 11. Note that the third horizontal fin 43 has a length, which is longer than that of the second horizontal fin 42, in the front/rear direction (or in the flowing direction of air-conditioning air). Also note that the fifth horizontal fin 45 has a length, which is longer than that of the fourth horizontal fin 44, in the front/rear direction (or in the flowing direction of air-conditioning air).

As illustrated FIG. 1, the left swing shafts 46L of the respective horizontal fins 46 are provided with a horizontal-fin-side link 47, which is disposed fixedly at the leading ends, respectively. The horizontal-fin-side links 47 comprise a leading end 470, and a connector 471, respectively. The leading ends 470 extend parallelly to the left swing shafts 46L. The connectors 471 connect the leading ends 470 to the left swing shafts 46L substantially perpendicularly. Thus, the leading ends 470 are disposed in a stepwise manner with respect to the left swing shafts 46L by way of the connectors 471. As described above, the respective left swing shafts 46L are fitted swingably through the left wall of the retainer body 10. Note that the leading end 470 and connector 471 of the respective horizontal-fin-side links 47 are exposed on the left side of the left wall of the retainer body 10. A horizontal-fins link member 55 is further disposed on the left side of the left wall of the retainer body 10. The horizontal-fins link member 55 comprises a body 550, a base 551, and an input element 552. The body 550 is formed as a long plate shape. The base 551 is formed as a substantially letter-U shape, and is provided at the leading end (or downward front end) of the body 550. The input element 552 is formed as a rod shape, which extends in the right/left direction, and is provided at the opened opposite end of the base 551. The leading ends 470 of the horizontal-fin-side links 47 of the left swing shafts 46L are fitted swingably through the horizontal-fins link member 55, respectively.

As illustrated in FIG. 2, for instance, the operating knob 5 is provided with a horizontal-fins driver 51 on the bottom side. The horizontal-fins driver 51 extends downward and forward slightly obliquely in the drawing. As best shown in FIG. 1, the horizontal-fins driver 51 is provided with a driving-force input element 510 at the leading end. The driving-force input element 510 is formed as a sphere shape substantially. The horizontal-fins driver 51 is connected to the horizontal-fins link member 55 by way of a connector 56. The connector 56 comprises a base 560, two fastening-leg elements 561, paired two driving-force retaining elements 562, and a connecting-leg element 563. The base 560 is formed as a plate substantially. The two fastening-leg elements 561 are disposed at the longitudinal opposite ends of the base 560 so as to protrude upward therefrom. Moreover, the fastening-leg elements 561 are provided with a through hole, respectively. The paired two driving-force retaining elements 562 are disposed at the longitudinal middle of the base 560, and are formed so as to protrude in the same upward direction as the fastening-leg elements 561 extend. Moreover, the paired two driving-force retaining elements 562 extend parallelly to the longitudinal direction of the base 560. Thus, the paired two driving-force retaining elements 562 make paired two upright minor walls, which are separated away from each other in the direction perpendicular to the longitudinal direction of the base 560 (i.e., in the front/rear direction). The connecting-leg element 563 is disposed at one of the longitudinal opposite ends of the base 560 (i.e., the left opposite end thereof in FIG. 1) so as to protrude downward (i.e., in the opposite direction to the extending direction of the fastening-leg elements 561). As shown in FIG. 2, for instance, the connecting-leg element 563 is provided with a slot, which opens rearward. Moreover, as can be seen from FIG. 1, two slidably-retaining rods 110, which are provided on the rear surface of the bezel 11, are fitted into the through holes of the fastening-leg elements 561. Since the slidably-retaining rods 110 are disposed so as to extend in the right/left direction, the connector 56 is disposed slidably in the right/left direction relatively to the bezel 11.

As illustrated in FIG. 1, the driving-force retaining elements 562 hold the driving-force input element 510 of the horizontal-fins driver 51 in the space formed therebetween. Moreover, the input element 552 of the horizontal-fins link member 55 is fitted into the slot of the connecting-leg element 563. Thus, the connector 56 is disposed slidably in the right/left direction relatively to the horizontal-fins link member 55 as well. When a user applies a force to the operating knob 5 in the up/down direction to swing the operating knob 5 in the up/down direction, the connector 56 swings in the up/down direction. When the connector 56 swings in the up/down direction, the horizontal-fins link member 55 slides in the up/down direction. Note that the connector 56 is disposed slidably in the right/left direction not only relatively to the bezel 11 but also relatively to the horizontal-fins link member 55. As a result, even when the operating knob 5 swings in the right/left direction to slide the connector 56 in the right/left direction, no force acts onto the horizontal-fins link member 55 in the right/left direction.

As designated with the alternate long-and-short lines in FIG. 5, a first imaginary plane 61 and a second imaginary plane 62 are parallel to each other. Note that the first imaginary plane 61 passes through the horizontal swing shaft 46 of the second horizontal fin 42 (see FIG. 1) and the horizontal swing shaft 46 of the third horizontal fin 43 (see FIG. 1); and that the second imaginary plane 62 passes through the horizontal swing shaft 46 of the fourth horizontal fin 44 (see FIG. 1) and the horizontal swing shaft 46 of the fifth horizontal fin 45 (see FIG. 1). On the other hand, a third imaginary plane 63 crosses the first imaginary plane 61 and the second imaginary plane 62. Note that the third imaginary plane 63 passes through the horizontal swing shaft 46 of the first horizontal fin 41 (see FIG. 1) and the horizontal swing shaft 46 of the second horizontal fin 42 (see FIG. 1). Moreover, a fourth imaginary plane 64 crosses the first imaginary plane 61 and the second imaginary plane 62. Note that the fourth imaginary plane 64 passes through the horizontal swing shaft 46 of the third horizontal fin 43 (see FIG. 1) and the horizontal swing shaft 46 of the fourth horizontal fin 44 (see FIG. 1). In short, the imaginary planes 61 and 62 (or 63 and 64), which pass through the horizontal swing shafts 46 of the horizontal swing fins 40 belonging to the same fin sub-assembly, are parallel to each other. However, the imaginary planes 61 and 63 as well as 64 (or 62 and 63 as well as 64), which pass through the horizontal shafts 46 of the horizontal fins 40 neighboring to each other but belonging to the different fin sub-assemblies, cross each other.

As illustrated in FIG. 1 and FIG. 2, for instance, the bottom wall of the retainer body 10 is provided with a guide groove 15 and a retainer-side guide 16. The guide groove 15 extends in the right/left direction, and opens forward and upward obliquely. The retainer-side guide 16 is formed as a hinge shape. The retainer-side guide 16 comprises a swing element 160, and a driven element 161. The swing element 160 is formed as a long plate shape. The driven element 161 is formed as a long plate shape similarly. The swing element 160 and the driven element 161 are disposed in the front/rear direction of the retainer body 10, and are connected swingably to each other.

As illustrated in FIG. 1, the swing element 160 is provided with a left swing shaft 46L and a right swing shaft 46R in the same manner as the respective horizontal fins 40. The left swing shaft 46L and right swing shaft 46R are disposed at the opposite ends of the swing element 160 on the side thereof which is opposite to the side with the driven element 161 disposed, i.e., on the front side thereof. The right swing shaft 46R of the swing element 160 is supported swingably to the right wall of the retainer body 10. The left swing shaft 46L of the swing element 160 is located more frontward and downward than the left swing shaft 46L of the fifth horizontal fin 45 is located, and is supported swingably to the left wall of the retainer body 10. The left swing shaft 46L of the swing element 160 is provided with a retainer-side horizontal link element 48, which is disposed fixedly at the leading end. The retainer-side horizontal link element 48, similarly to the horizontal-fin-side link elements 47, comprises a leading end 480, and a connector 481. The leading end 480 is fitted swingably through the horizontal-fins link member 55.

As illustrated in FIG. 1, the driven element 161 is provided with a slide engager 162. The slide engager 162 is disposed on one of the opposite sides of the driven element 161 that is opposite to the side with the swing element 160 disposed, i.e., on the rear side thereof. The slide engager 162 extends parallelly to the longitudinal direction of the driven element 161. As shown in FIG. 2, for instance, the slide engager 162 engages with the guide groove 16, and additionally slides within the guide groove 15 in the front/rear direction.

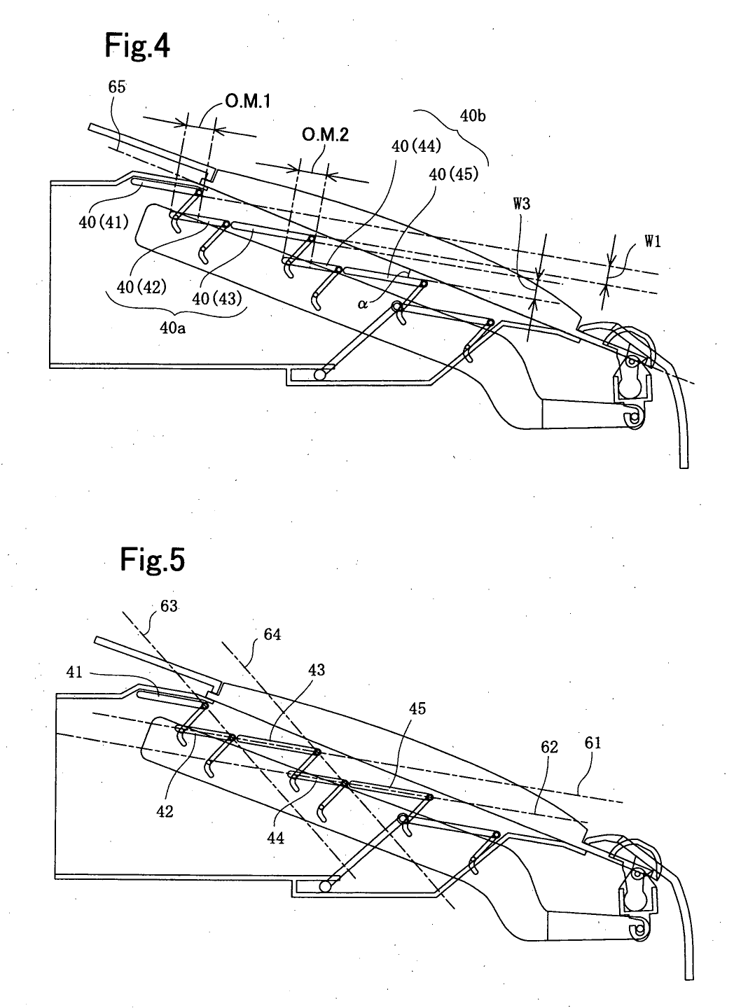

In the air-conditioning register according to Example of the present invention, the respective horizontal fins 40 swing synchronously between first positions shown in FIG. 4 and second positions shown in FIG. 2. The first positions specified in FIG. 4 are the predetermined positions of the horizontal fins 40. As can be seen from FIGS. 2, 3 and 4, in the air-conditioning register according to Example, an angle α, which the horizontal fins 40, being located at the predetermined positions shown in FIG. 4, and an outlet plane 65 make, is smaller than an angle β, which the horizontal fins 40, being located at the other positions shown in FIGS. 2 and 3, and the outlet plane 65 make. In the following descriptions, the positions of the horizontal fins 40 shown in FIG. 4 will be referred to as “downwardly-directing positions”; the positions of the horizontal fins 40 shown in FIG. 2 will be referred to as “upwardly-directing positions”; and the positions of the horizontal fins 40 shown in FIG. 3 will be referred to as “neutral positions.”

Hereinafter, the operations of the air-conditioning register according to Example of the present invention will be described.

At the upwardly-directing positions shown in FIG. 2, the horizontal fins 40 are disposed so that the front opposite ends are directed upward and the rear opposite ends are directed downward. Thus, at the upwardly-directing positions, the horizontal fins 40 control the flowing direction of air-conditioning air upward. In this instance, a clearance W1 between the first horizontal fin 41 and the second horizontal fin 42, a clearance W2 between the second horizontal fin 42 and the third horizontal fin 43, a clearance W3 between the third horizontal fin 43 and the fourth horizontal fin 44, and a clearance W4 between the fourth horizontal fin 44 and the fifth horizontal fin 45 make the flow passage of air-conditioning air, respectively. In short, the clearances between the neighboring horizontal fins 40 make the flow passages of air-conditioning air, respectively.

When a user applies a downward force to the operating knob under the circumstances that the horizontal fins 40 are disposed at the upwardly-directing positions shown in FIG. 2, the operating knob 5 swings downward, that is, in the clockwise direction in FIG. 2. As the operating knob 5 thus swings, the horizontal-fins link member 55 slides upward, because it is supported swingably to the horizontal-fins driver 51 of the operating knob 5 by way of the connector 56. The upwardly-sliding horizontal-fins link member 55 presses the leading ends 470 of the fin-side horizontal-link elements 47 of the horizontal fins 40 upward. Therefore, the horizontal fins 40 are swung synchronously about the left swing shaft 46L and right swing shaft 46R, respectively, in the clockwise direction in FIG. 2, and are disposed at the neutral positions shown in FIG. 3 eventually.

At the neutral positions shown in FIG. 3, the horizontal fins 40 are disposed so that the front opposite ends are directed upward slightly and the rear opposite ends are directed downward slightly. Thus, at the neutral positions, the horizontal fins 40 control the flowing direction of air-conditioning air upward slightly. In this instance, too, the clearances W1 through W4 between the neighboring horizontal fins 40 make the flow passages of air-conditioning air, respectively.

When a user applies a furthermore downward force to the operating knob 5 under the circumstances that the horizontal fins 40 are disposed at the neutral positions shown in FIG. 3, the operating knob 5 swings furthermore downward, that is, furthermore in the clockwise direction in FIG. 3. Therefore, the horizontal fins 40 are swung synchronously about the left swing shaft 46L and right swing shaft 46R, respectively, furthermore in the clockwise direction in FIG. 3, and are disposed at the downwardly-directing positions shown in FIG. 4 eventually. In this instance, as illustrated in FIG. 4, the horizontal fins 40 belonging to the same first fin sub-assembly 40a, the second horizontal fin 42 and third horizontal fins 43, are disposed one after another consecutively in a linear manner. Moreover, the horizontal fins 40 belonging to the same second fin sub-assembly 40b, the fourth horizontal fin 44 and fifth horizontal fins 45, too, are disposed one after another consecutively in a linear manner.

At the downwardly-directing positions shown in FIG. 4, the horizontal fins 40 are disposed so that the front opposite ends are directed downward and the rear opposite ends are directed upward. Thus, at the downwardly-directing positions, the horizontal fins 40 control the flowing direction of air-conditioning air downward.

Note that, at the downwardly-directing positions shown in FIG. 4, the horizontal fins 40 belonging to the same first fin sub-assembly 40a, the second horizontal fin 42 and third horizontal fins 43, are disposed one after another consecutively in a linear manner. Moreover, the horizontal fins 40 belonging to the same second fin sub-assembly 40b, the fourth horizontal fin 44 and fifth horizontal fins 45, too, are disposed one after another consecutively in a linear manner. Consequently, the clearance W1 between the first horizontal fin 41 and the second horizontal fin 42, and the clearance W3 between the third horizontal fin 43 and the fourth horizontal fin 44 make the flow passage of air-conditioning air, respectively. In short, the clearances between the horizontal fins 40, which neighbor to each other but do not belong to the same fin sub-assembly, make the flow passages of air-conditioning air, respectively.

In the air-conditioning register according to Example of the present invention, the number of the horizontal fins 40 is five pieces at the upwardly-directing positions and neutral position, but is reduced to three pieces (i.e., the first horizontal fin 41, the first fin sub-assembly 40a, and the second fin sub-assembly 40b) at the downwardly-directing positions. Therefore, the air-conditioning register according to Example can securely produce fully large flow passages of air-conditioning air when the horizontal fins 40 are located at the downwardly-directing positions. Moreover, in the air-conditioning register according to Example, the overlapping magnitude O.M.1 between the first horizontal fin 41 and the second horizontal fin 42 is great sufficiently; and the overlapping magnitude O.M.2 between the third horizontal fin 43 and the fourth horizontal fin 44 is great sufficiently; when the horizontal fins 40 are located at the downwardly-directing positions; as illustrated in FIG. 4. Hence, the air-conditioning register according to Example can control the flowing direction of air-conditioning air with high accuracy.

In addition, as best shown in FIG. 5, the air-conditioning register according to Example of the present invention comprises first imaginary plane 61 and the second imaginary plane 62, which are parallel to each other; and further comprises the third imaginary plane 63 and fourth imaginary plane 64, which cross the first imaginary plane 61 and the second imaginary plane 62 with each other; when the horizontal fins 40 are located at the downwardly-directing positions. Accordingly, all of the horizontal fins 40 are not disposed one after another consecutively when horizontal fins 40 are located at the downwardly-directing positions. Consequently, contrary to the conventional air-conditioning register, the air-conditioning register according to Example can securely produce fully large flow passages of air-conditioning air when the horizontal fins 40 are located at the downwardly-directing positions.

All in all, the air-conditioning register according to Example of the present invention can inhibit the enlargement pressure loss, can reduce noises, and can control the flowing direction of air-conditioning air with high accuracy.

Note that, in the air-conditioning register according to Example of the present invention, the swing element 160 of the retainer-side guide 16 swings synchronously with the horizontal fins 40 in the clockwise direction in FIG. 2 when swinging the horizontal fins 40 from the upwardly-directing positions to the downwardly-directing positions. In this instance, the swing element 160 pulls one of the opposite ends of the driven element 161, which is connected swingably to the swing element 160, so that the driven element 161 slides forward while directing the one of the opposite ends upward. Accordingly, while directing the swing element 160 parallelly to the fifth horizontal fin 45, the bottom wall of the retainer body 10 deforms so that the opening between the bottom wall and the fifth horizontal fin 45 diminishes. Consequently, the flow passage of air-conditioning air, which the opening between the fifth horizontal fin 45 and the bottom wall of the retainer 1 makes, is turned into being parallel to the passages of air-conditioning air, which the openings between the neighboring horizontal fins 40 make. Consequently, in the air-conditioning register according to Example, not only the horizontal fins 40 but also the bottom wall of the retainer 1 can control the flowing direction of air-conditioning air. As a result, the air-conditioning register according to Example can control the blowing direction of air-conditioning air with much higher accuracy.

Moreover, it is advisable that the air-conditioning register according to Example of the present invention can be provided with the vertical fins 30, which are disposed to contact with the neighboring vertical fins 30 when they swing by a predetermined angle. In such a preferable mode, the neighboring vertical fins 30 can shut off the flow passages of air-conditioning air. Thus, it is possible to turn the air-conditioning register according to Example into a so-called fin shut-off type air-conditioning register.

Note that, in the air-conditioning register according to Example of the present invention, the imaginary planes 61 and 62 (or 63 and 64), which pass through the horizontal swing shafts 46 of the horizontal fins 40 belonging to the same fin sub-assembly, are parallel to each other; but that the imaginary planes 61 and 63 as well as 64 (or 62 and 63 as well as 64), which pass through the horizontal swing shafts 46 of the horizontal fins 40 neighboring to each other but belonging to the different fin sub-assemblies, cross each other. Accordingly, the horizontal-fin assembly might possibly exhibit relatively poor decorativeness. However, the horizontal-fin assembly 4 is disposed in the rear of the vertical-fin assembly 3. To put it differently, the vertical-fin assembly 3 is disposed in front of the horizontal-fin assembly 4. Consequently, the horizontal-fin assembly 4 is less visible to a user. Therefore, the air-conditioning register according to Example is good in terms of the decorativeness as well.

Having now fully described the present invention, it will be apparent to one of ordinary skill in the art that many changes and modifications can be made thereto without departing from the spirit or scope of the present invention as set forth herein including the appended claims.

What is claimed is:

1. A register for air conditioning, comprising:
a cylinder-shaped retainer demarcating a flow passage for air-conditioning air and an outlet opening therefor; and
a fin assembly comprising a plurality of fins, the fins disposed parallelly to each other and swingably about a swing shaft, respectively, inside the retainer;
the fin assembly comprising a fin sub-assembly, the fin sub-assembly comprising the fins, which neighbor to each other, in a quantity of from two or more to less than a total number of the fins;
the fins, which belong to an identical fin sub-assembly, making a first imaginary plane, which passes the swing shafts of the fins;
the fins, which neighbor to each other but are free of belonging to the identical fin sub-assembly, making a second imaginary plane, which passes the swing shafts of the fins;
the first imaginary plane and the second imaginary plane crossing to each other; and
the fins, which belong to the identical fin sub-assembly, being disposed one after another consecutively when the fins swing to a predetermined position, respectively.

2. The register set forth in claim 1, wherein the fins, which belong to the identical fin sub-assembly, are disposed one after another consecutively in a linear manner when the fins swing to the predetermined position, respectively.

3. The register set forth in claim 1, wherein:
the retainer makes a third imaginary plane, which involves the outlet opening;
the third imaginary plane and the fins, which have swung to the predetermined position, make a first angle;
the third imaginary plane and the fins, which are located at positions other than the predetermined position, make a second angle; and
the first angle is smaller than the second angle.

4. The register set forth in claim 1, wherein:
the retainer makes a third imaginary plane, which involves the outlet opening; and
the third imaginary plane crosses an extending direction of the retainer at an angle other than a right angle.

5. The register set forth in claim 1, wherein the fins swing in an up/down direction with respect to the retainer, and control a blowing direction of the air-conditioning air downward at the predetermined position.

6. The register set forth in claim 1 further comprising a second fin assembly which is disposed in front of the fin assembly and comprises a plurality of fins disposed parallelly to each other and swingably about a swing shaft, respectively, inside the retainer.
